(19) United States
(12) Patent Application Publication
(10) Pub. No.: US 2010/0070299 A1
(43) Pub. Date: Mar. 18, 2010

(54) TIME MANAGEMENT IN A HEALTHCARE FACILITY

(75) Inventors: Cornelis Pauwel Datema, Best (NL); Laszlo Herczegh, Eindhoven (NL); Stephen Robert Heath, Andover, MA (US); Sachin Behere, Andover, MA (US); Lesh Parameswaran, Eindhoven (NL); George Marmaropoulos, Valhalla, NY (US); Fritz Winderl, Highland Heights, OH (US); Jennifer Bryniarski, Highland Heights, OH (US); Dawn Marie Maniawski, Highland Heights, OH (US); Estelle Hilas, Highland Heights, OH (US); Julianne Suhy, Highland Heights, OH (US)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/515,438

(22) PCT Filed: Nov. 23, 2007
(86) PCT No.: PCT/IB07/54769

§ 371 Date: May 19, 2009

(30) Foreign Application Priority Data
Nov. 24, 2006 (EP) 06124759.9

(51) Int. Cl. G06Q 50/00; G06Q 10/00

(52) U.S. Cl. 705/2

(57) ABSTRACT

A time management system for monitoring a patient in a healthcare facility is disclosed herein. The time management system comprises a monitoring device to monitor the progress of a procedure being undergone by the patient in the healthcare facility and output a monitored signal indicative of the progress of the procedure, as well as an indicator to indicate the progress of the procedure based on at least the monitored signal.

### FIELD OF THE INVENTION

The invention relates to the field of healthcare, particularly to time management in a healthcare facility.

### BACKGROUND OF THE INVENTION

Positron emission tomography (PET) examinations can typically take a fairly long time, as mentioned in a report of the American Association of Physicists in Medicine entitled “AAPM Task Group 108: PET and PET/CT Shielding Requirements”, Medical Physics, Volume 3, Issue 1, pp. 4-15, January 2006. For example, after the injection of a radiopharmaceutical, patients may have to wait for as long as 90 minutes before they are imaged in a PET scanner. Also, the data acquisition process for the scan may take up to 60 minutes. Thus the total PET procedure could take upwards of two and a half hours.

During the 90-minute waiting period, also called the uptake period, the radiopharmaceutical distributes itself through the patient's body. Physical movement must be minimized during this period so as to reduce uptake of the radiopharmaceutical into the skeletal muscles. In most PET facilities, a patient preparation room in which the patient may wait during the uptake period is a requirement. In fact, a busy PET facility may have more than one patient in the uptake area, or more than one patient preparation rooms.

### SUMMARY OF THE INVENTION

Similar to PET, other imaging modalities like X-ray computed tomography (CT) and magnetic resonance (MR) imaging can also take comparable time periods for completion. Staying still (i.e. without voluntary physical movement) during a procedure lasting such a long time is not easy for many patients and especially difficult for children. Furthermore, some patients may be nervous, leading to an increased risk of physical movement taking place. In certain cases, such movement could lead to severe degradation in image quality, sometimes necessitating a repeat scan leading to increased radiation exposure to the patient. Repeat scans add to the cost of the procedure and increase patient throughput time, both of which are undesirable.

Often, as in the case of X-ray, PET, X-ray CT, or MR imaging, it is not possible for another person to be in the immediate vicinity of the patient in order to calm them down, advise them on when to hold still, or monitor their status. In some cases, patient movement can be reduced by distracting them from the ongoing procedure and allowing them to concentrate on something else. Alternatively, in other cases, displaying the progress of the procedure that they are undergoing could make them more compliant to a technician's instructions, thereby increasing the overall speed of the procedure. Often, in addition to (or alternatively to) displaying the progress of a particular part of the procedure, for example the time remaining in a scan, it may also be helpful to indicate what percentage of the total procedure has been completed. Examples of such a “total” procedure time could be the sum total of the uptake period, the scan time, and the recovery period in a PET scan or, in the case of a minimally-invasive image-guided biopsy procedure, the sum total of the patient preparation time, scan (or imaging data acquisition) time, time taken for the biopsy, and post-operative recovery time.

Often, it is also important to inform persons other than the patient, for example a caregiver or a relative of the patient, of the progress of the procedure. This could assist in better time management, for example by enabling the caregiver to prepare the next patient or informing the relative to complete any paperwork required to discharge the patient from the healthcare facility, etc.

In all these cases, although good time management seems to be of high importance for the clinical outcome of the procedure, no tools seem to be readily available for this. Therefore, it is desirable to have a time management tool that can keep various participants in a clinical procedure informed about the progress of the procedure. It is also desirable to have a method of managing time in a healthcare facility as well as a computer program to implement such a method.

Accordingly, a time management system for monitoring a patient in a healthcare facility is disclosed herein. The time management system comprises a monitoring device to monitor the progress of a procedure being undergone by the patient in the healthcare facility and output a monitored signal indicative of the progress of the procedure, as well as an indicator to indicate the progress of the procedure based on at least the monitored signal.

Furthermore, a method of managing time in a healthcare facility is also disclosed herein, the method comprising the steps of monitoring the progress of a procedure being undergone by a patient in the healthcare facility and outputting a monitored signal indicative of the progress of the procedure, and of indicating the progress of the procedure based on at least the monitored signal.

Furthermore, a computer program to implement a method of managing time in a healthcare facility is also disclosed herein, the computer program comprising instructions to monitor the progress of a procedure being undergone by a patient in the healthcare facility and output a monitored signal indicative of the progress of the procedure, and to indicate the progress of the procedure based on at least the monitored signal, when the computer program is run on a computer.

### BRIEF DESCRIPTION OF THE DRAWINGS

These and other aspects will be described in detail hereinafter, by way of example, on the basis of the following embodiments, with reference to the accompanying drawings, wherein:

FIG. 1 shows an embodiment of the time management system in a healthcare facility;

FIG. 2 shows a second embodiment of the time management system, wherein indicators display a time remaining for a patient in a waiting room;

FIG. 3 shows a third embodiment of the time management system, wherein a relative of the patient undergoing a scan is notified of the progress of the procedure;

FIG. 4 shows examples of display schemes that could be used to indicate the progress of the procedure;

FIG. 5 shows a fourth embodiment of the time management system, wherein a patient in a waiting room is kept updated on the progress of the procedure by means of audiovisual triggers in the waiting room;

FIG. 6 shows a fifth embodiment of the time management system, wherein a patient is kept updated on the progress of the procedure by means of audiovisual triggers in a scanning room; and

FIG. 7 shows a control system that is capable of implementing the method of time management in a healthcare facility as disclosed herein.

Corresponding reference numerals when used in the various Figures represent corresponding elements in the Figures.

### DETAILED DESCRIPTION OF EMBODIMENTS

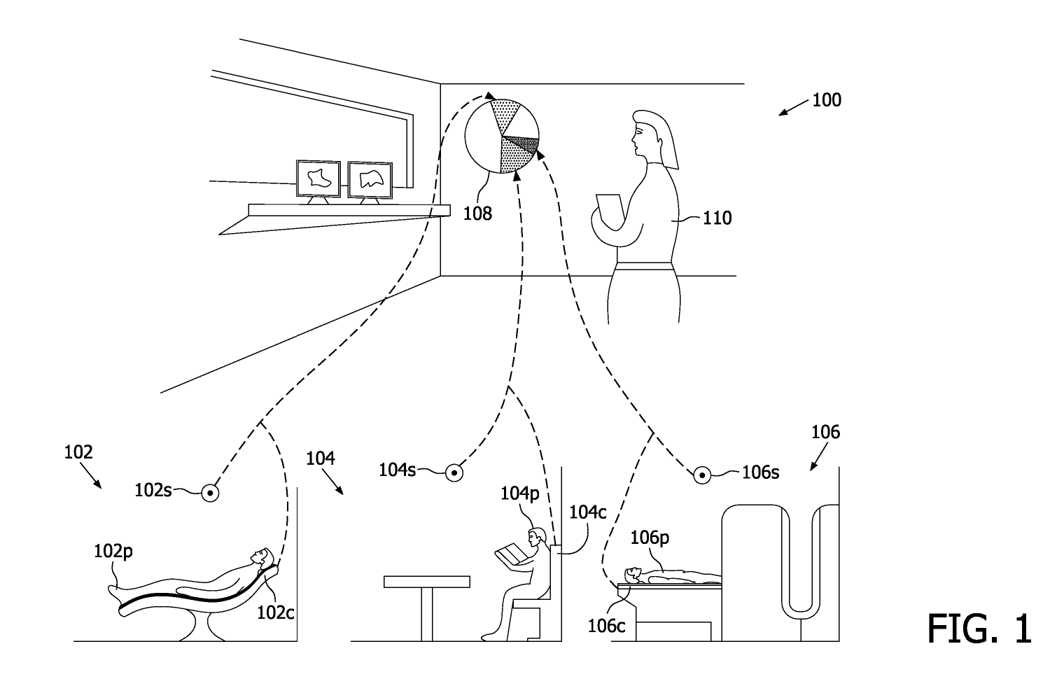

FIG. 1 shows a healthcare facility comprising a monitoring room 100, an uptake room 102, a waiting room 104, and an imaging room 106. A first sensor 102s in the uptake room 102 detects or monitors an environmental parameter in the uptake room 102, while a second sensor 102c detects or monitors a physiological parameter of a first patient 102p. Similarly, a third and a fourth sensor 104s, 104c monitor an environmental parameter in the waiting room 104 and a physiological parameter of a second patient 104p, respectively, while a fifth and a sixth sensor 106s, 106c monitor an environmental parameter in the imaging room 106 and a physiological parameter of a third patient 106p, respectively. The various detected or monitored parameters are transmitted to a display station 108 in the monitoring area 100, where a caregiver 110 monitors the progress of the procedure.

In a specific embodiment, the caregiver 110 is able to monitor, at a glance, the status of multiple patients 102p, 104p and 106p in different areas of the healthcare facility 100. The various patients may be in different stages of the procedure. For example, the second patient 104p in the waiting room 104 may be waiting for a radiopharmaceutical injection, while the first patient 102p in the uptake room 102 has already received the radiopharmaceutical injection and is in the uptake period during which the radiopharmaceutical distributes itself throughout the body. In the meantime, a third patient 106p is undergoing a PET scan in a scanning room 106. The caregiver 110 is able to monitor all the patients, as well as the stage of the procedure that each patient is currently at, on an integrated display device 108.

Monitoring multiple patients simultaneously in the healthcare facility may be achieved by tagging the patients using RFID (active/passive) tags. Other tracking mechanisms like WIFI may also be used to monitor the patients' whereabouts. By displaying this information throughout the department, the staff in the healthcare institution can have a quick overview of all relevant information. In public places, the information may be accessible to authorized personnel through self-identification on a computer console.

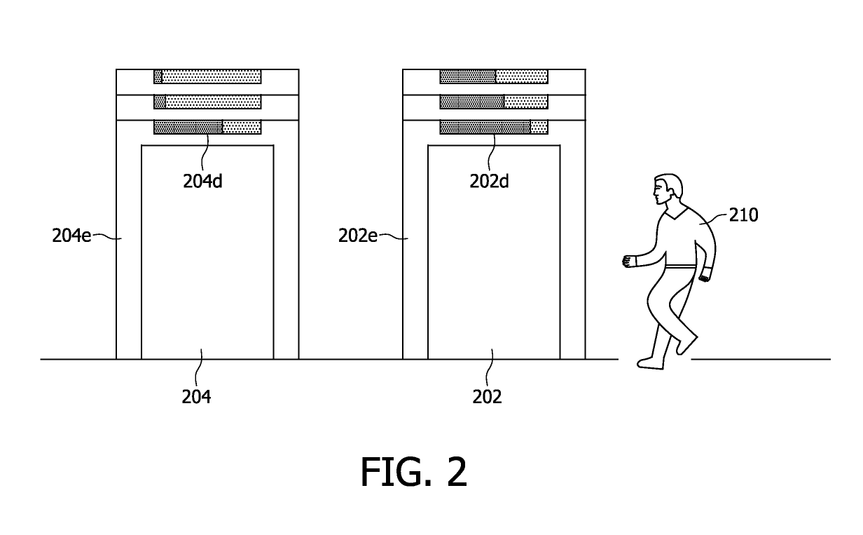

FIG. 2 shows the entrances 202e, 204e to two different uptake rooms 202, 204, respectively, in a PET facility. Multiple indicators 202d, 204d on the entrances 202e, 204e display the occupancy status of the room as well as the time remaining for the occupancy, to a person 210 walking by the uptake rooms.

Often, healthcare institutions have dedicated rooms in which the patient is requested to wait for some period of time. In a PET facility, for example, the patient may have to wait for up to one and a half hours in a special waiting room to enable proper uptake of an injected radiopharmaceutical. Waiting rooms that serve such a purpose are often called uptake rooms, and the waiting period spent inside the uptake room is often called the uptake period.

Inside an uptake room, the patient first winds down and relaxes for about 30 minutes. At the end of this 30-minute relaxation period, the patient is injected with a radiopharmaceutical, following which the patient has to wait for up to 60 minutes for proper uptake of the radiopharmaceutical. During this uptake period (as well as during the preceding relaxation period), it may be useful to indicate both the occupancy status of the uptake room and the amount of waiting time left to people outside the waiting room. For example, if the uptake room 202 can accommodate 3 people, then the occupancy status can be monitored by automatically sensing and counting the number of people who enter and exit the room. Using RFID tracking technology, it is also possible to keep track of the time that each patient has spent in the uptake room. In such a case, each indicator bar in the set of indicators 202d, 204d could represent the time spent by a different patient. A similar indicator system could be used in other types of waiting rooms as well, for example a holding area where the patient is monitored while recovering from anesthesia or a recovery room where a patient is monitored after a cardiac stress test. Under these (and other similar) circumstances, it may be useful to also monitor certain physiological parameters, like the heart rate or respiratory rate, which at times could indicate the recovery level of the patient. Thus, if a patient recovers faster, there would be no need to retain him/her in the recovery room, and the procedure could be expedited accordingly.

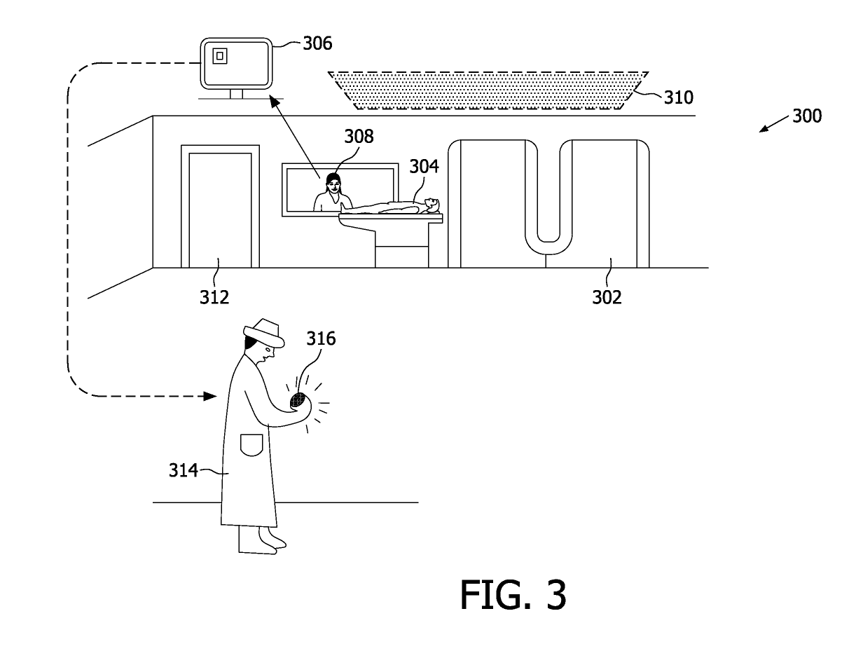

FIG. 3 shows an embodiment of the proposed time management system that displays different types of information to different people involved in the procedure. A patient 304 being scanned in a scanner 302 in an imaging suite 300 is monitored by a caregiver 308, while a loved one 314 waits in a remote location for information about the progress of the procedure. The term “loved one” is to be taken to mean a family member or other relative, a friend, or any other person who is concerned about the wellbeing of the patient and is interested in a successful outcome of the procedure being undergone by the patient. A visual trigger 310 projected on the roof of the imaging suite 300 keeps the patient 304 engaged while a display 306 in the operator's or caregiver's area of the imaging suite 300 conveys relevant status information about the patient 304 to the caregiver 308. In the figure, this display 306 is shown as mounted over the entrance 312 to the imaging suite 300, but it is to be understood that the display 306 is visible only to the caregiver outside the scanning room, and not to the patient 304 undergoing the scan. The progress of the procedure is transmitted to the loved one 314 in a remote location, who can read the status from a handheld device 316.

It is sometimes necessary to display different types of information to different people involved in a medical procedure. For example, a patient may only be interested in the amount of time remaining for the scan to get done while a loved one may only be interested in getting an alert message indicating when the procedure is actually completed. The caregiver, on the other hand, will require much more detailed information about the status of the patient, time remaining for the procedure, the number and status of other patients waiting to be scanned in the scanner, and maybe even the availability of clean sheets to be used in the imaging suite 300. In fact, any parameter that could potentially alter the pace of progress of the procedure may be monitored and displayed, either in a continuous fashion, intermittently, or simply as a warning, depending on the type of the parameter.

Monitored physiological parameters may include cardiac and respiratory rates of the patient, or vibration measurements from the patient table that indicate movement of the patient. Any significant variations in these parameters need to be addressed immediately, as they could potentially slow the pace of progress of the procedure. Therefore, information of this type may be displayed on a continuous basis to a caregiver. On the other hand, an indication of the time remaining to the end-of-procedure may be shown intermittently to the patient by projecting it on the ceiling, possibly in between some other programming that is being shown. In this way the patient is sufficiently distracted from the procedure and is yet informed of the progress of the procedure, so that it does not seem inordinately long. A loved one, for example a relative or a friend, probably only needs to know the progress of the procedures at set intervals. For example, the loved one could be alerted via a text message or a graphic display when the procedure is 25%, 50%, 75% and 100% complete. Thus, everyone involved in the procedure can receive a different representation of time remaining for the procedure to finish. The caregiver could receive the exact remaining time, the patient could receive intermittent indication of progression towards the end of the procedure and the loved one could receive an alert when the procedure is completed.

A personal indicator device given to the loved one indicates the approximate time remaining for the completion of the procedure. Having this indicator device with them, a loved one is free to walk around within the healthcare facility, e.g. the cafeteria, information centre, library, etc., and does not need to sit and wait in an (often crowded) waiting room, which can be a distressing, and sometimes overwhelming, experience. The loved one is alerted remotely when the procedure finishes. The alert may be a simple buzz, message, or light indication.

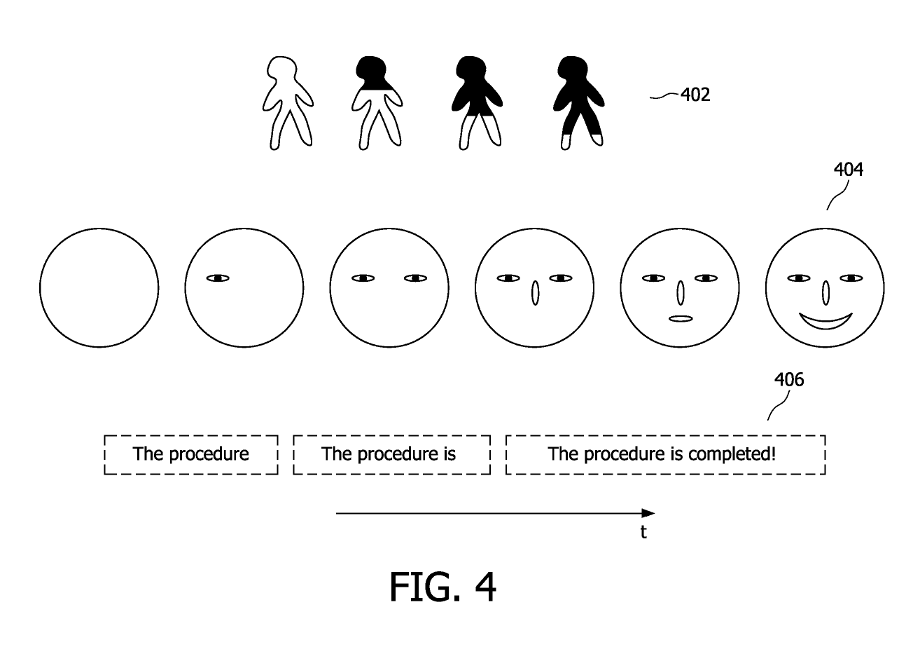

Alternatively, the indication may be graphical or textual as shown in FIG. 4. The progress of the actual scan may be indicated by a person slowly filling up, as shown in panel 402. Alternatively, a smiley face that starts with only a circle could get completed depending on the progress of the procedure, as shown in panel 404. Alternatively, the indicator may be a simple text message that indicates when the procedure is complete, as shown in panel 406. The axis marked t shows that the various pictures in each panel show the change in the indication over a period of time and should be read from left to right. Any of the above indications could be given both to the patient and to the loved one. By giving an indication about the status of the procedure without telling the exact remaining time, patients and loved ones will be kept engaged, yet not focused on the time aspect. Especially for the patient, this aspect is crucial within the PET-CT procedure as it will help to reduce restlessness of the patient, and thereby not unnecessarily delay the procedure.

The indication of the progress of the procedure may be a projection on a screen or wall, or on a computer monitor. Alternatively, it may be a physical object, for example a dial similar to a fuel gauge in an automobile, which indicates the status by the position of a pointer.

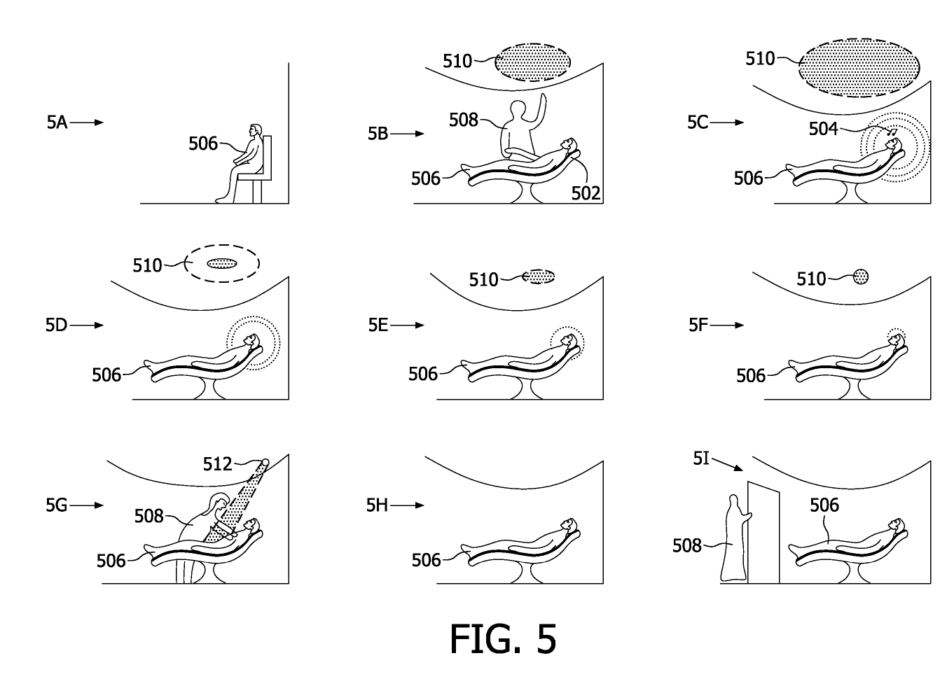

FIG. 5 shows an embodiment of the time management system used in an uptake room of a PET facility. A patient 506 is shown waiting in the uptake room, in picture 5A. In picture 5B, the patient 506 is positioned in a relaxation chair 502 in the uptake room, while a caregiver 508 gives instructions to the patient 506 to watch a graphical display 510 on the ceiling. Over a period of time, the graphical display 510 changes in size (or some other parameter like colour) to indicate the progression of the waiting period, as shown successively in the pictures 5B, 5C, 5D, 5E and 5F. At the end of the waiting period, a task light 512 is switched on, either automatically or by the caregiver 508, who then administers the radiopharmaceutical injection to the patient 506, as shown in picture 5G. The uptake period now begins during which the patient 506 is instructed to remain as still as possible, as shown in picture 5H. During this period, a different graphical display may be shown to the patient to encourage the patient to remain in a quiescent state. Such graphical displays should be designed such as to induce a sense of calm in the patient, and may be supported by soft sounds filling the room. Alternatively, and as is often the case, the uptake room is made almost dark and completely silent, so that the patient is as inactive as possible. At the end of the uptake period, the graphical display, if in use, is turned off and the caregiver 508 enters the uptake room to guide the patient 506 to the next step in the procedure, as shown in picture 51.

It may be noted that a sound trigger 504 (i.e., an audio indicator) like a beep that changes in volume or a song that changes in tempo may be used instead of a visual trigger such as the graphical display shown in the FIG. 5. It is also possible to use a combination of audio and visual indicators, as shown in picture 5C. Similar audio, visual or combined triggers may also be used in patient recovery rooms, for example while a patient is in a post-operative recovery stage.

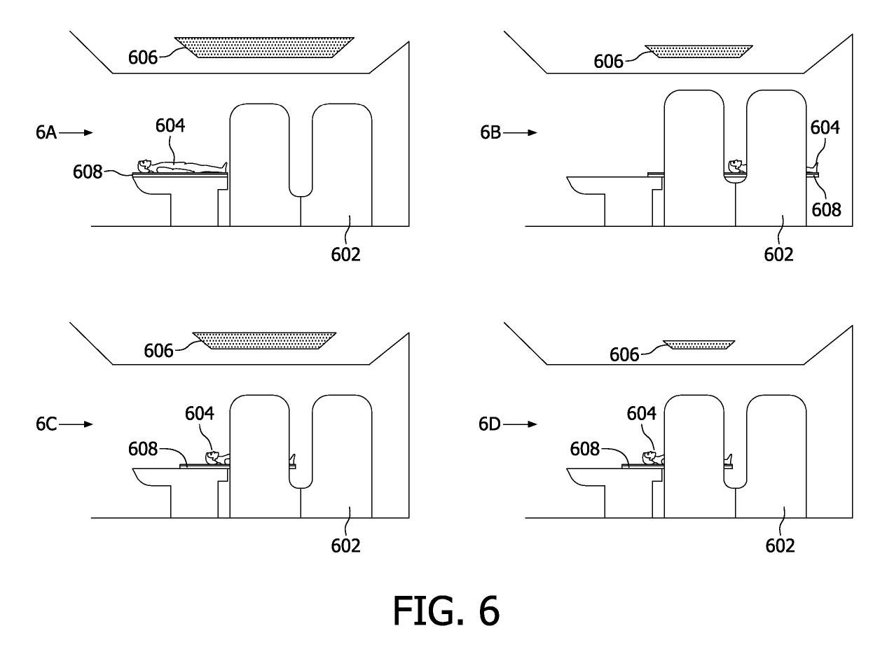

FIG. 6 shows an embodiment of the invention applied inside a scanning room. In picture 6A, a patient 604 is placed on a patient table 608. The patient 604 is moved into a scanner 602 in picture 6B and imaging is initiated. The progress of the procedure is displayed graphically on the ceiling of the imaging room, as shown by the graphic 606 in successive pictures 6A, 6B, 6C and 6D.

The patient table 608 may have embedded motion or vibration sensors (not shown) that continuously monitor the patient for motion. As excessive motion could degrade image quality and reduce its diagnostic value, the patient needs to be warned when such motion occurs. An effective way of doing this is to suddenly change the graphic projected on the ceiling, thereby catching the patient's attention. For example, if the time remaining for the procedure is being displayed as a circle of proportionate size on the ceiling, and the patient is watching it in anticipation of the end of the procedure, a sudden increase in the size of the graphic could warn the patient to hold still, as otherwise it would take longer for the procedure to end. Thus, the graphic could provide an incentive for the patient to hold still and thereby increase the pace of progress of the scan. Of course, the graphic could be any other representative figure, for example any of the depictions shown in FIG. 4. The change made to the graphic could depend on the graphic itself. For example, instead of changing the size of the smiley face (panel 404 in FIG. 4), the face could suddenly change to a “frowning face” (not shown). Such visual indicators of facial expressions are quite powerful in conveying messages, and may work especially well in the case of children.

While it is a fact that the patient often needs to hold as still as possible during a scan, it is also often the case that patients should not relax so much that they go to sleep.

This could be for a number of reasons like the need to respond to a caregiver's instructions or due to the fact that involuntary movements that occur naturally during sleep cannot be controlled. To prevent the patient from going to sleep, the graphic 606 could be made more interesting, for example a movie or news clipping or an animated cartoon, etc., that is combined with the appropriate soundtrack. Of course, instead of the visual triggers mentioned above, audio triggers may be used, in which the movie or news clipping is interrupted, and a voice or a loud beep reminds the patient to hold still.

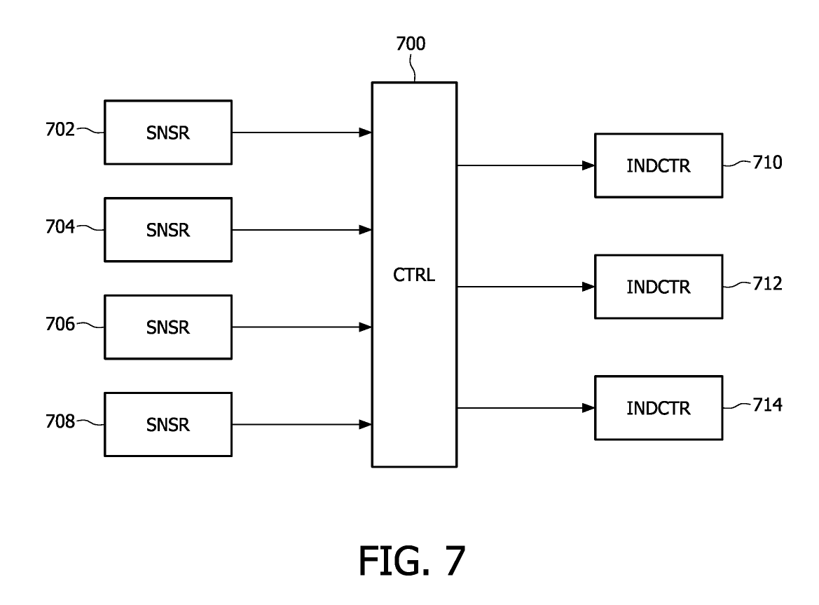

FIG. 7 shows a control system that is capable of implementing the method of time management in a healthcare facility, as disclosed herein. Various sensors (SNSR) 702, 704, 706 and 708 located in different areas of a healthcare facility detect parameters such as patient motion, room temperature, etc., and feed their inputs to a control system (CTRL) 700. Based on the inputs from the various sensors and an algorithm that is capable of determining a next course of action, the control system 700 controls various indicators (INDCTR) 710, 712 and 714 located in various parts of the healthcare facility. The detected parameters may include environmental or system parameters like the number of patients in a queue waiting for scanning, the time spent by each patient in a particular stage of the procedure, etc., as well as some physiological parameters like patient movement, respiratory and cardiac rate, etc.

The control system may be implemented as a combination of hardware and software, for example in the form of a computer program running on a computer. The computer program may reside on a computer readable medium, for example a CD-ROM, a DVD, a floppy disk, a memory stick, a magnetic tape, a hard disk, or any other tangible medium that is readable by a computer. The computer program may also be a downloadable program that is downloaded or otherwise transferred to the computer, for example via the Internet. The computer program may be transferred to the computer via a transfer means such as an optical drive, a magnetic tape drive, a floppy drive, a USB or other computer port, an Ethernet port, etc.

The order in the described embodiments of the disclosed devices or the described implementations of the disclosed methods is not mandatory. A person skilled in the art may change the order of steps or perform steps concurrently using threading models, multi-processor systems or multiple processes without departing from the disclosed concepts.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The disclosed methods can be implemented by means of hardware comprising several distinct elements, and by means of a suitably programmed computer. In the system claims enumerating several means, several of these means can be embodied by one and the same item of computer readable software or hardware. The mere fact that certain measures are recited in mutually different dependent claims does not indicate that a combination of these measures cannot be used to advantage.

1. A time management system for a healthcare facility, comprising:
a monitoring device to monitor the progress of a procedure being undergone by a patient in the healthcare facility and output a monitored signal indicative of the progress of the procedure; and
an indicator to indicate the progress of the procedure based on at least the monitored signal.

2. The time management system of claim 1, wherein the procedure includes scanning the patient on a positron emission tomography scanner and/or an X-ray computed tomography scanner.

3. The time management system of claim 1, wherein the procedure includes an uptake period for the patient in a waiting room after the patient has been injected with a radiopharmaceutical.

4. The time management system of claim 1, wherein the monitoring device is arranged to monitor a physiological parameter of the patient and/or an environmental parameter in the healthcare facility to estimate the progress of the procedure.

5. The time management system of claim 1, wherein the indicator is arranged to indicate the progress of the procedure to the patient him/herself.

6. The time management system of claim 1, wherein the indicator is arranged to indicate the progress of the procedure at a remote location.

7. A method of managing time in a healthcare facility, comprising:
monitoring the progress of a procedure being undergone by a patient in the healthcare facility and outputting a monitored signal indicative of the progress of the procedure; and
indicating the progress of the procedure based on at least the monitored signal.

8. A computer program to implement a method of managing time in a healthcare facility, the computer program comprising instructions to:
monitor the progress of a procedure being undergone by a patient in the healthcare facility and output a monitored signal indicative of the progress of the procedure; and
indicate the progress of the procedure based on at least the monitored signal, when the computer program is run on a computer.
